(19) United States
(12) Patent Application Publication
(10) Pub. No.: US 2014/0160152 A1
(43) Pub. Date: Jun. 12, 2014

(54) METHODS AND SYSTEMS FOR INTEGRATED PLOT TRAINING

(71) Applicant: GENERAL ELECTRIC COMPANY, Schenectady, NY (US)

(72) Inventors: Scott Terrell Williams, Minden, NV (US); David Michael Robertson, Bellevue, WA (US)

(73) Assignee: GENERAL ELECTRIC COMPANY, Schenectady, NY (US)

(21) Appl. No.: 13/707,914

(22) Filed: Dec. 7, 2012

(51) Int. Cl. G06T 7/00

(52) U.S. Cl. CPC G06T 7/0022
USPC 345/629; 345/440

(57) ABSTRACT

A method for correlating data collected from at least one sensor of a first machine of a first type with a malfunction of the first machine is provided. The method is implemented by a computing device. The method includes storing, in a memory coupled to the computing device, an analysis data set based on measurement information from the at least one sensor. The method further includes storing, in the memory, at least one reference data set corresponding with a malfunction of a second machine, the second machine being of the first type. Additionally, the method includes displaying, with a display device, a first plot representing the analysis data set. Further, the method includes displaying, with the display device, a second plot representing one reference data set of the at least one reference data set.

### BACKGROUND OF THE INVENTION

The field of the invention relates generally to displaying information, and more particularly to methods and systems for use in identifying a malfunction in a machine or other asset based on a plot of data collected from the asset.

In a facility in which resources are received, processed, and converted by machines into electricity or another product, it is often beneficial to monitor the status of the machines to determine whether they are operating normally. To facilitate such monitoring, in at least some facilities, sensors are positioned adjacent to such machines to measure one or more parameters or characteristics, such as vibrations, temperatures, voltages or currents associated with the machines. In some environments with multiple machines and multiple sensors, the information collected by the sensors is transmitted to a central computer for evaluation by the computer and/or a user of the computer. Additionally, the information may be stored in a database and reviewed on an as-needed basis.

Data stored as described above may relate to a particular type of measurement for a particular machine. The data may indicate the existence of a malfunction in the machine. However, identifying the existence and nature of a malfunction from the data, even when the data is displayed in a plot, can be difficult for those who are not familiar with the machine or diagnostic analysis per plot and data type.

### BRIEF DESCRIPTION OF THE INVENTION

In one aspect, a method for correlating data collected from at least one sensor of a first machine of a first type with a malfunction of the first machine is provided. The method is implemented by a computing device. The method includes storing, in a memory coupled to the computing device, an analysis data set based on measurement information from the at least one sensor. The method further includes storing, in the memory, at least one reference data set corresponding with a malfunction of a second machine, the second machine being of the first type. Additionally, the method includes displaying, with a display device, a first plot representing the analysis data set. Further, the method includes displaying, with the display device, a second plot representing one reference data set of the at least one reference data set.

In another aspect, a computing device for correlating data collected from at least one sensor of a first machine of a first type with a malfunction of the first machine is provided. The computing device includes a processor, a display device coupled to the processor, and a memory coupled to the processor. The memory contains processor-executable instructions for performing the steps of storing, in the memory, an analysis data set based on measurement information from the at least one sensor and storing, in the memory, at least one reference data set corresponding with a malfunction of a second machine, the second machine being of the first type. The memory further contains processor-executable instructions for displaying, with the display device, a first plot representing the analysis data set and displaying, with the display device, a second plot representing one reference data set of the at least one reference data set.

In another aspect, a system for correlating data collected from at least one sensor of a first machine of a first type with a malfunction of said first machine is provided. The system includes at least one sensor, the first machine, a computing device comprising a processor, a display device coupled to the processor, and a memory coupled to the processor. The memory contains processor-executable instructions for performing the steps of storing, in the memory, an analysis data set based on measurement information from said at least one sensor and storing, in the memory, at least one reference data set corresponding with a malfunction of a second machine, the second machine being of the first type. The memory further contains processor-executable instructions for displaying, with the display device, a first plot representing the analysis data set and displaying, with the display device, a second plot representing one reference data set of at least one reference data set.

### BRIEF DESCRIPTION OF THE DRAWINGS

FIG. 1 is a block diagram of an exemplary system that may be used to collect information from multiple sensors from multiple machines.

FIG. 2 is a block diagram of an exemplary system that may be used for displaying measurement information from at least one sensor in a machine.

FIG. 3 illustrates an exemplary computing device that may be used with the system shown in FIG. 2.

FIG. 4 is an exemplary plot that may be generated using the system shown in FIG. 2.

FIG. 5 is an exemplary plot that may be generated using the system shown in FIG. 2.

FIG. 6 is an exemplary plot that may be generated using the system shown in FIG. 2.

FIG. 7 indicates an order of storing test or analytic data prior to creating or storing reference data sets. The reference data sets would be collected and stored first. The reference data would be shipped with the product and compared to the test/analytic data set.

### DETAILED DESCRIPTION OF THE INVENTION

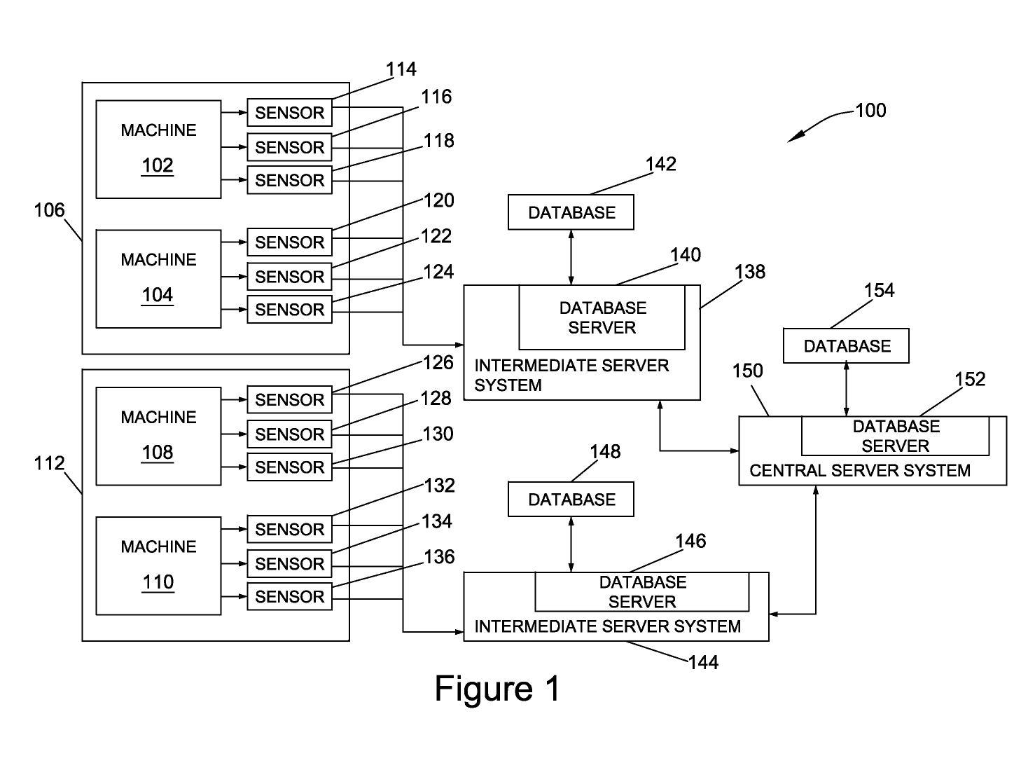

FIG. 1 is a block diagram of an exemplary system 100 for use in collecting information from multiple sensors 114, 116, 118, 120, 122, 124, 126, 128, 130, 132, 134, and 136 from multiple machines 102, 104, 108, and 110. In the exemplary embodiment, machines 102 and 104 are located in a facility 106. Likewise, machines 108 and 110 are located in a facility 112. Facilities 106 and 112 may be involved, for example, in the generation of electricity. For example, facilities 106 and 112, and more specifically, machines 102, 104, 108, and 110, may be used in converting a raw resource into electricity. In other embodiments, facilities 106 and 112 may be used in any other process involving multiple machines. In other embodiments, facilities 106 and 112 may be used in different processes. In yet other embodiments, there may be any number of facilities and/or machines.

Sensors 114, 116, and 118 are communicatively coupled to machine 102. In the exemplary embodiment, sensor 114 measures a temperature of machine 102, sensor 116 measures a vibration of machine 102, and sensor 118 measures a voltage of machine 102. Likewise, sensors 120, 122, and 124 are also communicatively coupled to machine 104. In the exemplary embodiment, sensor 120 measures a temperature of machine 104, sensor 122 measures a vibration of machine 104, and sensor 124 measures a voltage of machine 104. Sensors 126, 128, and 130 are communicatively coupled to machine 108. Sensor 126 measures a temperature of machine 108, sensor 128 measures a vibration of machine 108, and sensor 130 measures a voltage of machine 108. Additionally, sensors 132, 134, and 136 are also communicatively coupled to machine 110 to enable sensor 132 to measure a temperature of machine 110, sensor 134 to measure a vibration of machine 110, and sensor 136 to measure a voltage of machine 110.

An intermediate server system 138 is communicatively coupled to sensors 114, 116, 118, 120, 122, and 124. Intermediate server system 138 includes a database server 140 that stores and retrieves information in a database 142. Intermediate server system 138 receives measurement data from sensors 114, 116, 118, 120, 122, and 124 and causes database server 140 to store the received measurement data in database 142. Similarly, an intermediate server system 144 is communicatively coupled to sensors 126, 128, 130, 132, 134, and 136. Intermediate server system 144 includes a database server 146 that stores and retrieves information in a database 148. Intermediate server system 144 receives measurement data from sensors 126, 128, 130, 132, 134, and 136 and causes database server 146 to store the received measurement data in database 148.

A central server system 150 is coupled to intermediate server systems 138 and 144. Similar to intermediate server systems 138 and 144, central server system 150 includes a database server 152 that stores and retrieves information in a database 154. Central server system 150 transmits instructions to intermediate server systems 138 and 144 to provide measurement data stored in databases 142 and 148, respectively, for storage in database 154. In the exemplary embodiment, central server system 150 transmits instructions and receives the corresponding measurement data at regular intervals, for example, daily. In the exemplary embodiment, for efficiency, the transmissions from central server system 150 ensure that only measurement information that has been added or updated since the previous time the intermediate server systems 138 and 144 provided measurement information to central server system 150 are transmitted to central server system 150. After receiving the measurement information from intermediate server systems 138 and 144, central server system 150 causes database server 152 to store the received measurement information in database 154. Other embodiments may include a different number of sensors and/or sensors that may measure different characteristics or behaviors of one or more machines. Additionally, in alternative embodiments, there are no intermediate server systems and all sensors are coupled to a central server system. In yet other embodiments, all sensors are coupled to a single computing device.

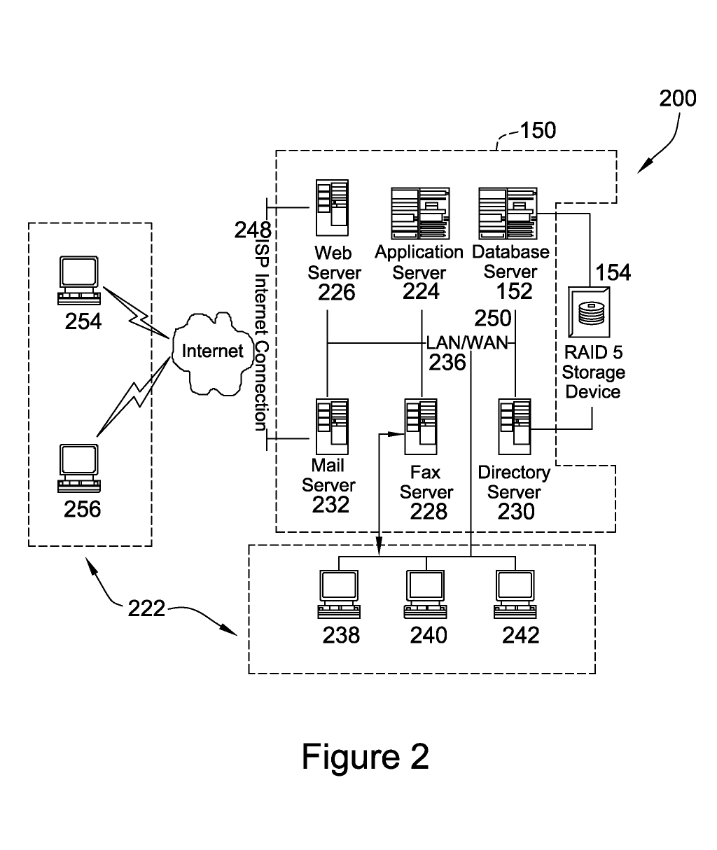

FIG. 2 is a block diagram of an exemplary system 200 for use in displaying measurement information from at least one sensor (such as sensor 114) in a machine (such as machine 102) in accordance with an embodiment of the present invention. Components in system 200, identical to components of system 100 (shown in FIG. 1), are identified in FIG. 2 using the same reference numerals used in FIG. 1. System 200 includes central server system 150 and client systems 222. Central server system 150 also includes database server 152, an application server 224, a web server 226, a fax server 228, a directory server 230, and a mail server 232. A disk storage unit containing database 154 is coupled to database server 152 and to directory server 230. Servers 152, 224, 226, 228, 230, and 232 are communicatively coupled in a local area network (LAN) 236. In addition, a system administrator's workstation 238, a user workstation 240, and a supervisor's workstation 242 are coupled to LAN 236. Alternatively, workstations 238, 240, and 242 are coupled to LAN 236 using an Internet link or are connected through an Intranet. In the exemplary embodiment, database 154 includes reference data sets of sensor information pertaining to normal operations and malfunctions of a variety of machines, including machines that are similar or identical to machines 102, 104, 108, and 110. In other embodiments, such reference data sets of sensor information are stored in a remote database which is accessible through a communications network, for example, the Internet.

Each workstation, 238, 240, and 242, is a computing device that includes a web browser. Although the functions performed at the workstations are typically illustrated as being performed at respective workstations 238, 240, and 242, such functions can be performed at one of many computing devices coupled to LAN 236. Workstations 238, 240, and 242 are illustrated as being associated with separate functions only to facilitate an understanding of the different types of functions that can be performed by individuals having access to LAN 236.

Central server system 150 is configured to be communicatively coupled to entities outside LAN 236 as well, such as workstations 254 and 256 via an Internet connection 248. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 250, local area network 236 could be used in place of WAN 250.

In the exemplary embodiment, any authorized individual or entity having a workstation 238, 240, 242, 254, 256 may access system 200. At least one of the client systems includes a manager workstation 256 located at a remote location. Workstations 254 and 256 include a computing device having a web browser. Also, workstations 254 and 256 are configured to communicate with server system 150. Furthermore, fax server 228 is configured to communicate with remotely located client systems 222 using a telephone link.

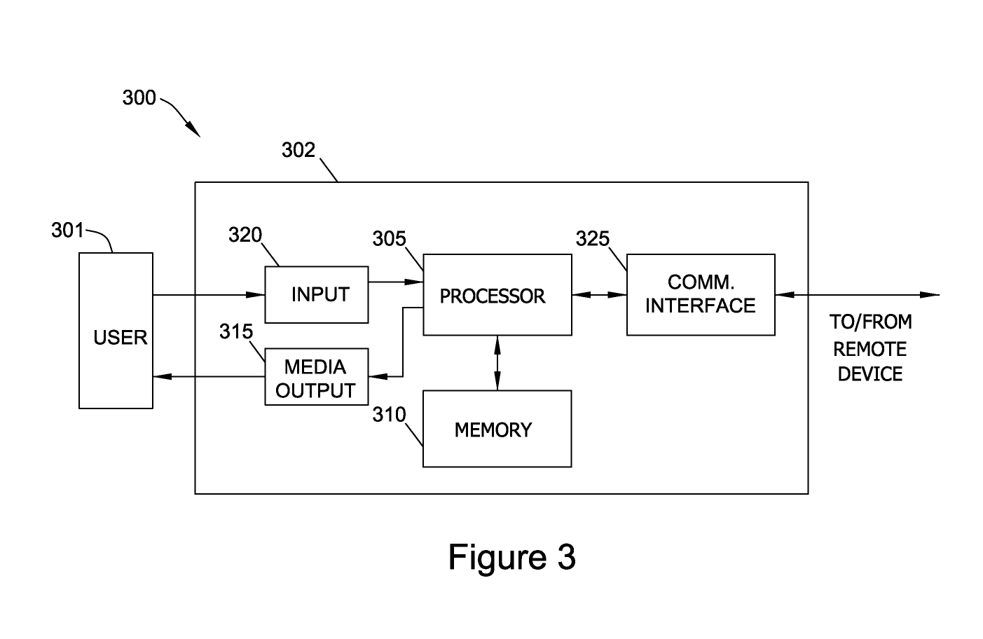

FIG. 3 illustrates an exemplary computing device 302 that may be used with system 100 and/or system 200. For example, computing device 302 is representative of intermediate server 138, intermediate server 144, any of servers 152, 224, 226, 228, 230, 232, of central server system 150, and client systems 222. Computing device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or other data to be stored and retrieved. Memory area 310 may include one or more computer readable media.

Computing device 302 also includes at least one media output component 315 for presenting information to user 301. Media output component 315 is any component capable of conveying information to user 301. In some embodiments, media output component 315 includes an output adapter such as a video adapter and/or an audio adapter. An output adapter is operatively coupled to processor 305 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, at least one such display device and/or audio device is included in media output component 315.

In some embodiments, computing device 302 includes an input device 320 for receiving input from user 301. Input device 320 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 315 and input device 320.

Computing device 302 may also include a communication interface 325, which is communicatively couplable to a remote computing device such as a server system 138, 144, 150 or a client system 222. Communication interface 325 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 310 are, for example, processor-executable instructions for providing a user interface to user 301 via media output component 315 and, optionally, receiving and processing input from input device 320. A user interface may include, among other possibilities, a web browser and client application. Web browsers enable users, such as user 301, to display and interact with media and other information typically embedded on a web page or a website from a server system, for example central server system 150. A client application allows a user, such as user 301, to display and interact with a server system, such as central server system 150, in a manner that does not necessarily involve a web page or website and which may offload more storage and/or processing functions to the client application from the server system.

Memory area 310 may include, but is not limited to, any computer-operated hardware suitable for storing and/or retrieving processor-executable instructions and/or data. Memory area 310 may include random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). Further, memory area 310 may include multiple storage units such as hard disks or solid state disks in a redundant array of inexpensive disks (RAID) configuration. Memory area 310 may include a storage area network (SAN) and/or a network attached storage (NAS) system. In some embodiments, memory area 310 includes memory that is integrated in computing device 302. For example, computing device 302 may include one or more hard disk drives as memory 310. Memory area 310 may also include memory that is external to computing device 302 and may be accessed by a plurality of computing devices 302. The above memory types are exemplary only, and are thus not limiting as to the types of memory usable for storage of a processor-executable instructions and/or data.

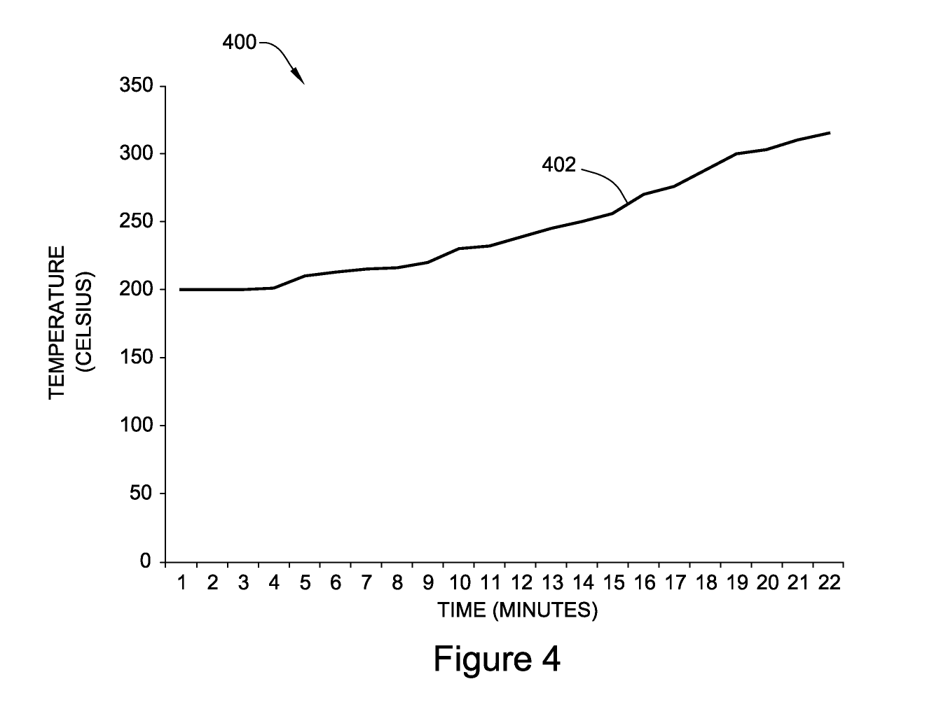

FIG. 4 is a plot 400 that may be generated using system 200 (shown in FIG. 2). Plot 400 may be displayed using a display device of media output component 315 (shown in FIG. 3). Plot 400 represents a data set of temperature information measured by sensor 114 (shown in FIG. 1) for machine 102 (shown in FIG. 1). The measurement information is stored in memory area 310 (shown in FIG. 3). As explained above, memory area 310 may include memory that is integrated into computing device 302 (shown in FIG. 3) and/or memory that is external, for example database 154 (FIGS. 1 and 2). Plot 400 includes a trend 402 showing a temperature increasing over time. A technician or other user viewing plot 400 may be unable to determine the cause of the increase in temperature over time and/or may not know that the trend 402 even represents a malfunction of machine 102.

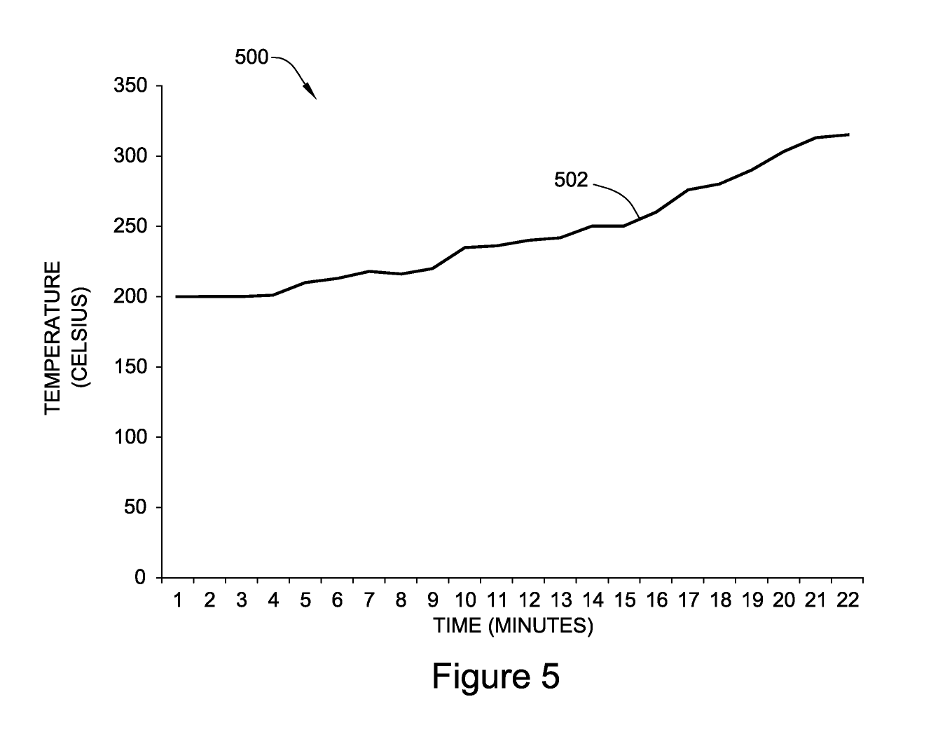

Stored in memory area 310 (shown in FIG. 3), is at least one reference data set of information pertaining to a malfunction of a machine that is of the same, or similar, type as machine 102 (shown in FIG. 1). Again, as explained above, memory area 310 may include memory that is integrated into computing device 302 and/or memory that is external, for example database 154 (FIGS. 1 and 2). This reference data set may be used to generate a second plot, as shown in FIG. 5.

FIG. 5 is a plot 500 that may be generated using system 200 (FIG. 2). Plot 500 may be displayed using a display device coupled to media output component 315 (FIG. 3) of computing device 302 (shown in FIG. 3). Plot 500 includes a trend 502 showing an increase in temperature over time. Plot 500 represents a malfunction in a component of a cooling system included in a machine that is of the same type as machine 102 (shown in FIG. 1). A user of computing device 302 (shown in FIG. 3), after seeing the similarity between trend 402 of plot 400 (shown in FIG. 4) and trend 502 of plot 500, may conclude that the corresponding component in the cooling system of machine 102 (shown in FIG. 1) must be malfunctioning. In the exemplary embodiment, a user would use input component 320 (shown in FIG. 3) of computing device 302 to select from a variety of reference data sets to view corresponding plots of malfunctions for machines identical or similar to machine 102. In some embodiments, computing device 302 may compare the data set represented in plot 400 with the reference data sets, determine a degree of similarity between each reference data set and the data set associated with plot 400, and select and display a plot of the reference data set most similar to the data set of plot 400. In some embodiments, computing device 302 may also display an indication of the degree of similarity and/or display a description of the malfunction associated with the selected reference data set. In further embodiments, computing device 302 may additionally display an explanation of why the plot looks the way it does. Additionally, in some embodiments, computing device 302 may additionally display a message that none of the reference data sets have enough correlation to the analysis data set to indicate the designated machine malfunction.

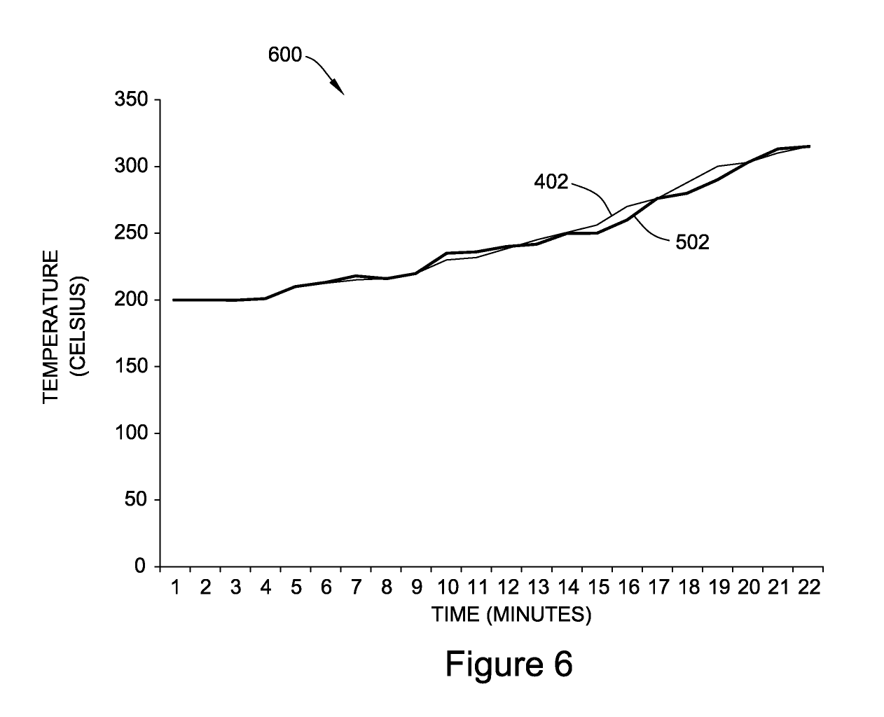

FIG. 6 is a plot 600 that may be generated using system 200. Plot 600 may be displayed using a display device coupled to media output component 315 (shown in FIG. 3) of a computing device. Plot 600 includes trend 402 of FIG. 4 and trend 502 of FIG. 5. That is, plots 400 and 500 are overlaid, forming plot 600. The similarity between trends 402 and 502 is apparent in plot 600. Overlaying plots 400 and 500 enables a user of computing device 302 (shown in FIG. 3) to visually judge the similarity between trends 402 and 502, and conclude that machine 102 is likely experiencing the malfunction associated with trend 502. That is, a user is able to determine from plot 600 that machine 102 (shown in FIG. 1) is experiencing a malfunction in a component of the cooling system of machine 102.

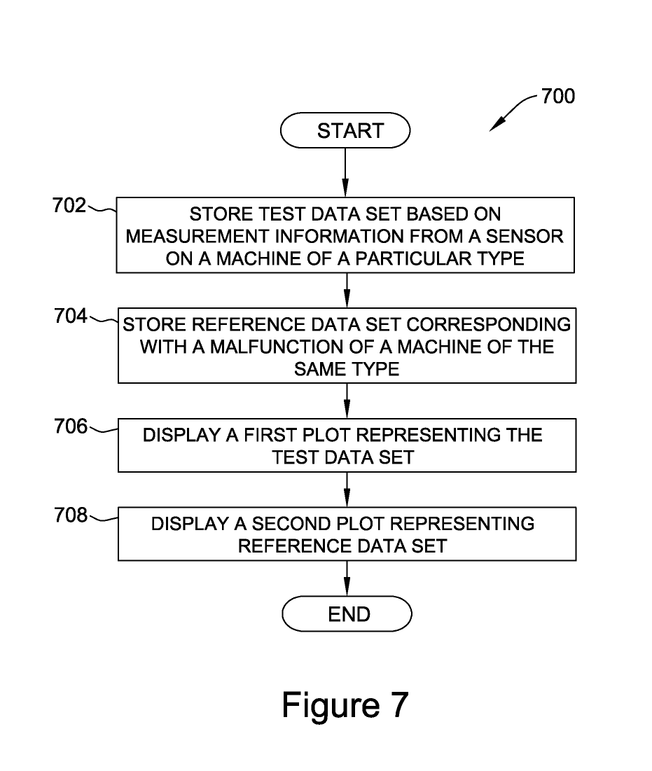

FIG. 7 is flowchart of a method 700 that may be implemented to correlate data collected from at least one sensor of a machine with a malfunction of the machine. The method 700 may be implemented by one or more computing devices 302 (shown in FIG. 3) of systems 100 (shown in FIG. 1) and system 200 (shown in FIG. 2). At step 702, at least one computing device 302 of system 200 stores, in memory area 310 (shown in FIG. 3), an analysis data set based on measurement information from at least one sensor on a machine of a particular type. For example, the analysis data set may be the temperature information from sensor 114 (shown in FIG. 1), discussed with reference to FIGS. 4 and 6. Again, sensor 114 is associated with machine 102 (shown in FIG. 1). At step 704, at least one computing device 302 stores in memory area 310 at least one reference data set. Each reference data set corresponds to a malfunction of a machine of the same type as machine 102. Steps 702 and 704 may be carried out in the opposite order. At step 706, at least one computing device 302 displays a first plot representing the analysis data set, for example plot 400 of FIG. 4. At step 708, at least one computing device 302 displays a second plot representing a reference data set stored in step 704. For example, the second plot may be plot 500 (shown in FIG. 5) or plot 600 (shown in FIG. 6), which is a combination of plots 400 (shown in FIGS. 4) and 500 (shown in FIG. 5).

In one embodiment, the steps of method 700 are carried out exclusively by central server system 150 (shown in FIGS. 1 and 2) and the plot is displayed on a visual display local to central server system 150. In other embodiments, a computing device communicatively coupled to central server system 150, such as workstation 254 (shown in FIG. 2), requests and receives the data sets, stores the data sets in memory 310 (shown in FIG. 3), and displays the plots as discussed above. In other embodiments, a portion of the steps of method 700 are carried out by central server system 150 and a second portion of the steps are carried out by a computing device communicatively coupled to central server system 150. In other embodiments, method 700 is carried out by a single computing device 302 (shown in FIG. 3), coupled to one or more sensors.

A technical effect of systems and methods described herein includes at least one of: (a) storing, in a memory of a computing device, an analysis data set based on measurement information from the at least one sensor; (b) storing, in the memory, at least one reference data set corresponding with a malfunction of a second machine, the second machine being of the first type; (c) displaying, with a display device of a computing device, a first plot representing the analysis data set; and (d) displaying, with the display device, a second plot representing one reference data set of the at least one reference data set.

As compared to known methods and systems for plotting data collected from a sensor of a machine, the methods and systems described herein generate plots that more easily allow a user to perceive that a specific malfunction has occurred in the machine. Exemplary embodiments of methods and systems for plotting such data are described above in detail. The methods and systems described herein are not limited to the specific embodiments described herein, but rather, components of the systems and/or steps of the methods may be utilized independently and separately from other components and/or steps described herein

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for correlating data collected from at least one sensor of a first machine of a first type with a malfunction of the first machine, said method implemented by a computing device, said method comprising:
storing, in a memory coupled to the computing device, an analysis data set based on measurement information from the at least one sensor;
storing, in the memory, at least one reference data set corresponding with a malfunction of a second machine, the second machine being of the first type;
displaying, with a display device, a first plot representing the analysis data set; and
displaying, with the display device, a second plot representing one reference data set of the at least one reference data set.

2. The method of claim 1, wherein the at least one reference data set is a plurality of reference data sets, each reference data set in the plurality of reference data sets corresponds to a different malfunction of the second machine, and displaying the second plot includes representing one of the plurality of reference data sets.

3. The method of claim 1, further comprising:
overlaying the second plot on the first plot or overlaying the first plot on the second plot.

4. The method of claim 1, wherein the at least one reference data set is a plurality of reference data sets, each reference data set in the plurality of reference data sets corresponds to a different malfunction of the second machine, and said method further comprises:
determining a degree of similarity between the analysis data set and each of the plurality of reference data sets;
determining which of the plurality of reference data sets has the largest degree of similarity with the analysis data set; and
representing, in the second plot, the reference data set with the largest degree of similarity with the analysis data set.

5. The method of claim 1, further comprising:
displaying, with the display device, a description of the malfunction associated with the data set represented by the second plot.

6. The method of claim 1, wherein the computing device is a first computing device, the first computing device further includes a communication interface communicatively coupled with a second computing device, and said method further comprises:
requesting, with the communication interface, at least one of the analysis data set and the at least one reference data set from the second computing device; and
receiving, with the communication interface, at least one of the analysis data set and the at least one reference data set from the second computing device.

7. The method of claim 2, wherein the computing device further includes an input device coupled to the processor, and said method further comprises:
receiving an input with the input device;
selecting one of the plurality of reference data sets based on the input; and
representing, in the second plot, the selected one of the plurality of reference data sets.

8. The method of claim 2, further comprising:
determining a degree of similarity between the first plot and the second plot; and
displaying, with the display device, the degree of similarity between the first plot and the second plot.

9. A computing device for correlating data collected from at least one sensor of a first machine of a first type with a malfunction of the first machine, said computing device comprising a processor, a display device coupled to said processor, and a memory coupled to said processor, said memory contains processor-executable instructions for performing the steps of:
storing, in said memory, an analysis data set based on measurement information from the at least one sensor;
storing, in said memory, at least one reference data set corresponding with a malfunction of a second machine, the second machine being of the first type;
displaying, with said display device, a first plot representing the analysis data set; and
displaying, with said display device, a second plot representing one reference data set of the at least one reference data set.

10. The computing device of claim 9, wherein the at least one reference data set is a plurality of reference data sets, each reference data set in the plurality of reference data sets corresponds to a different malfunction of the second machine, and said memory further contains processor-executable instructions such that displaying the second plot includes representing one of the plurality of reference data sets.

11. The computing device of claim 9, wherein said memory further contains processor-executable instructions for performing the step of:
overlaying the second plot on the first plot or overlaying the first plot on the second plot.

12. The computing device of claim 9, wherein the at least one reference data set is a plurality of reference data sets, each reference data set in the plurality of reference data sets corresponds to a different malfunction of the second machine, and said memory further contains processor-executable instructions for performing the steps of:
determining a degree of similarity between the analysis data set and each of the plurality of reference data sets;
determining which of the plurality of reference data sets has the largest degree of similarity with the analysis data set; and
representing, in the second plot, the reference data set with the largest degree of similarity with the analysis data set.

13. The computing device of claim 9, wherein said memory further contains processor-executable instructions for:
displaying, with the display device, a description of the malfunction associated with the data set represented by the second plot.

14. The computing device of claim 9, wherein said computing device is a first computing device, said first computing device further comprises a communication interface communicatively coupled with a second computing device, and said memory further contains processor-executable instructions for performing the steps of:
requesting, with said communication interface, at least one of the analysis data set and the at least one reference data set from the second computing device; and
receiving, with said communication interface, at least one of the analysis data set and the at least one reference data set from the second computing device.

15. The computing device of claim 10, further comprising an input device coupled to said processor, and said memory further contains processor-executable instructions for performing the steps of:
receiving an input with said input device;
selecting one of the plurality of reference data sets based on the input; and
representing, in the second plot, the selected one of the plurality of reference data sets.

16. The computing device of claim 10, wherein said memory further comprises processor-executable instructions for performing the steps of:
determining a degree of similarity between the first plot and the second plot; and
displaying, with said display device, the degree of similarity between the first plot and the second plot.

17. A system for correlating data collected from at least one sensor of a first machine of a first type with a malfunction of said first machine, said system comprising said at least one sensor, said first machine, a computing device comprising a processor, a display device coupled to said processor, and a memory coupled to said processor, said memory contains processor-executable instructions for performing the steps of:
storing, in said memory, a analysis data set based on measurement information from said at least one sensor;
storing, in said memory, at least one reference data set corresponding with a malfunction of a second machine, the second machine being of the first type;
displaying, with said display device, a first plot representing the analysis data set; and
displaying, with said display device, a second plot representing one reference data set of the at least one reference data set.

18. The system of claim 17, wherein the at least one reference data set is a plurality of reference data sets, each reference data set in the plurality of reference data sets corresponds to a different malfunction of the second machine, and said memory further contains processor-executable instructions such that displaying the second plot includes representing one of the plurality of reference data sets.

19. The system of claim 17, wherein said memory further contains processor-executable instructions for performing the step of:
overlaying the second plot on the first plot or overlaying the first plot on the second plot.

20. The system of claim 17, wherein the at least one reference data set is a plurality of reference data sets, each reference data set in the plurality of reference data sets corresponds to a different malfunction of the second machine, and said memory further contains processor-executable instructions for performing the steps of:
determining a degree of similarity between the analysis data set and each of the plurality of reference data sets;
determining which of the plurality of reference data sets has the largest degree of similarity with the analysis data set; and
representing, in the second plot, the reference data set with the largest degree of similarity with the analysis data set.
